(19) United States
(12) Patent Application Publication
(10) Pub. No.: US 2020/0226975 A1
(43) Pub. Date: Jul. 16, 2020

(54) BLIND SPOT REDUCTION SYSTEM

(71) Applicant: GENTEX CORPORATION, Zeeland, MI (US)

(72) Inventors: Sebastien C. Jaeger, Saugatuck, MI (US); Karri M. Kluting, Ravenna, MI (US); Mark R. Roth, Grand Rapids, MI (US); Brian D. Jewell, Grand Rapids, MI (US); Jonathan A. Morey, Ravenna, MI (US)

(73) Assignee: GENTEX CORPORATION, Zeeland, MI (US)

(21) Appl. No.: 16/739,317

(22) Filed: Jan. 10, 2020

Related U.S. Application Data
(60) Provisional application No. 62/792,921, filed on Jan. 16, 2019.

(51) Int. Cl. G09G 3/32; H04N 7/18; B60R 1/00; B60R 11/02; B60R 11/04

(52) U.S. Cl. CPC G09G 3/32; H04N 7/18; B60R 1/002; B60R 11/0229; B60R 11/04; B60R 2011/0022; G09G 2380/10; G09G 2360/06; B60R 2300/20; B60R 2300/101; G09G 2360/144

(57) ABSTRACT

A blind spot reduction system comprises a display element disposed on an interior surface of a pillar of a vehicle; at least one imager configured to capture images; and a processing system in communication with the display element and the at least one imager. The processing system may be configured to process the captured images; and the display element may be configured to display the processed images. The processed images may be images of a scene blocked from the view of a viewer by the pillar of the vehicle.

### CROSS REFERENCE TO RELATED APPLICATIONS

This application claims the benefit of and priority to U.S. Provisional Patent Application No. 62/792,921, filed on Jan. 16, 2019, entitled Blind Spot Reduction System, the entire disclosure of which is hereby incorporated herein by reference

### FIELD OF THE DISCLOSURE

This disclosure relates generally to displays, and in particular, to displays used in vehicles to reduce blind spots.

### BACKGROUND

Blind spots in a vehicle may result from the pillars or vertical supports around glass areas of a vehicle that support the roof of the vehicle. Vehicles may have several blind spots, and the blind spots may make it difficult for drivers to see areas outside the vehicle while looking through the windows or at the rear-view or side mirrors.

Vehicle pillars are generally present in pairs; i.e., a vehicle may have two A pillars, two B pillars, and so on. A vehicle may have several sets of pillars. Depending on the vehicle's size and configuration, it may have up to four sets of pillars, although more are theoretically possible. The front-most pillars are generally designated as the A pillars. The A pillars help support the roof and are located on either side of a vehicle's windshield. Moving from the front toward the rear of the vehicle, the next set of pillars is generally designated as B pillars, and they are often disposed between the front and rear doors of the vehicle. The C pillars, if present, are next and are usually the pillars disposed behind the rear door of the vehicle. Finally, in larger vehicles, if present, the D pillars may be disposed on either side of a rear window.

In some vehicles, ventilation ductwork and ventilation ports may be disposed in at least one pillar. In some vehicles, portions of seat belts and seat belt systems and/or supplemental restraint systems may be disposed within at least one set of pillars. In some vehicles, speakers or stereo components may be disposed in at least one pillar. As more vehicle components are located within pillars, pillars may become larger, and may cause larger blind spots for drivers.

### SUMMARY

According to an aspect, a blind spot reduction system may comprise a display element disposed on an interior surface of a pillar of a vehicle; at least one imager configured to capture images of a scene exterior to the vehicle; and a processing system in communication with the display element and the at least one imager. The processing system may be configured to process the captured images; and the display element may be configured to display the processed images. The blind spot reduction system further may comprise at least one position sensor in communication with the processing system; and the position sensor may be configured to determine a location of an object and to communicate the location to the processing system. The processing system may be configured to adjust displayed image based on the location of the object. The at least one imager may be configured to capture images of a scene to the exterior of the pillar and that may be blocked from the view of a vehicle occupant by the pillar; and the processing system may be configured to use the location of the object to adjust the captured images to cause the display element to display images of the scene behind the pillar and blocked from the view of the vehicle occupant. The blind spot reduction system further may comprise apertures in an exterior surface of the pillar; and the apertures may be configured to allow light to pass through the apertures from the exterior side of the pillar to an interior of the pillar. This may provide light to the display element.

The blind spot reduction system further may comprise a light source in communication with the processing system and configured to provide light to the display element. The display element may comprise at least one display panel; and the at least one display panel may comprise a light emitting diode.

The blind spot reduction system further may comprise an ambient light sensor in communication with the processing system and configured to provide inputs regarding ambient light levels to the processing system. The photosensitivity of the at least one imager may be adjusted based on the inputs generated by the ambient light sensor and communicated to the processing system.

The blind spot reduction system further may comprise a glare sensor in communication with the processing system and configured to provide inputs regarding glare to the processing system. The processing system may be configured to adjust the image displayed on the display element in response to the inputs generated by the glare sensor and communicated to the processing system.

The blind spot reduction system may comprise at least one of an ambient light sensor and a glare sensor; and the at least one of an ambient light sensor and glare sensor may be in communication with the processing system and may be configured to provide inputs to the processing system. The blind spot reduction system further may comprise an electro-optic element in communication with the processing system; the display element may be viewed through the electro-optic element; and the electro-optic element may be activated based on inputs provided to the processing system by the at least one of an ambient light sensor and glare sensor.

According to an aspect, a blind spot reduction system for a vehicle may comprise a display element disposed on an interior surface of a pillar of a vehicle; at least one imager having a field of view, the imager configured to capture images of a scene exterior to the vehicle; and a processing system in communication with the display element and the at least one imager. The processing system may be configured to process the captured images. The display element may be configured to display the processed images. The field of view of the imager may include a scene that is blocked from the view of a vehicle occupant by the pillar in which the display element is disposed.

According to an aspect, a method of reducing blind spots in a vehicle may comprise providing a display element, at least one imager, and a processing system; capturing images with the at least one imager; and displaying the captured images on the display element, wherein the display element is disposed on an interior surface of a vehicle pillar. The method may further comprise the step of processing, by the processing system, the captured images prior to display. The method may further comprise the step of providing at least one position sensor in communication with the processing system. The method may further comprise the step of determining, by the at least one position sensor, a location of an object, and communicating the location of the object to the processing system. The method may further comprise the step of adjusting, based on the received inputs from the at least one position, the displayed image in accordance with the inputs on the location of the object. The object may be the head or eyes of a viewer. The captured images may be images of a scene exterior to the vehicle, which scene is blocked from the view of the viewer by the vehicle pillar. The method may further comprise the steps of providing at least one of a glare sensor and an ambient light sensor in communication with and configured to provide inputs to the processing system; providing an electro-optic element disposed between the display element and the location of a viewer and in communication with the processing system; and adjusting the darkness of the electro-optic element based on inputs provided to the processing system by the at least one of the glare sensor and the ambient light sensor.

### BRIEF DESCRIPTION OF THE DRAWINGS

FIG. 1 is a schematic diagram of the blind spot reduction system of this disclosure;

FIG. 2 illustrates blind spot reduction system of this disclosure disposed within a pillar; and

FIG. 3 illustrates a flow chart of a method for reducing blind spots in a vehicle.

### DETAILED DESCRIPTION

Blind spots in vehicles may prevent drivers from seeing other vehicles and obstacles on the road. They are generally caused by pillars surrounding glass areas such as a windshield and/or windows of the vehicles. A system for reducing blind spots may help to alleviate the problems associated with them, thereby substantially minimizing or even eliminating the dangers associated with blind spots.

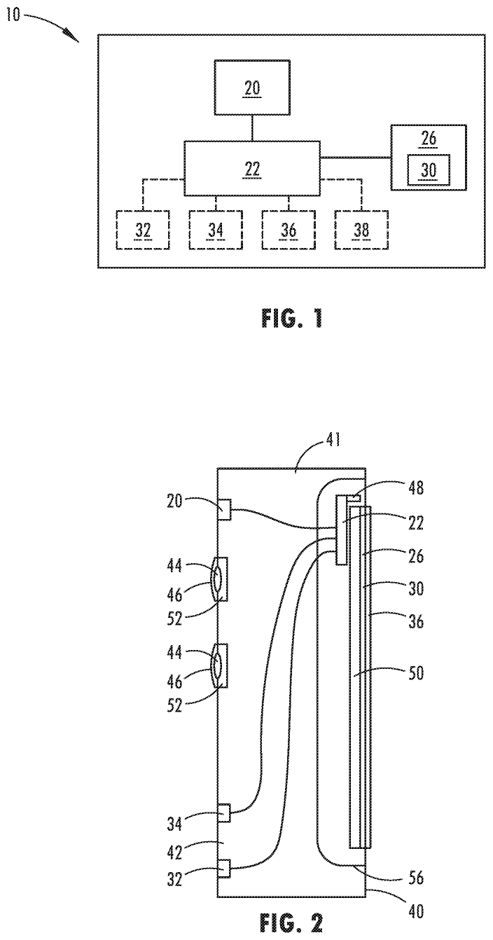

The present disclosure generally relates to a blind spot reduction system for displaying video images of a scene acquired by a camera or other imager onto a display element disposed on a pillar of a vehicle. The displayed images may be of the scene exterior to the vehicle and blocked from the view of the driver by the vehicle pillar. FIG. 1 shows an example of a blind spot reduction system 10, which includes at least one camera or other imager 20, a processing system 22 in communication with the at least one imager 20, and a display element 26 in communication with processing system 22. In the example shown, signals representative of a scene captured by the at least one imager 20 may be sent to processing system 22. Processing system 22 may produce images of the scene and cause those images to be displayed on display element 26. Display element 26 may comprise at least one display panel 30.

In some embodiments, blind spot reduction system 10 may further comprise at least one of an ambient light sensor 32 and a glare sensor 34. In some embodiments, processing system 22 may receive input from at least one of ambient light sensor 32 and glare sensor 34 and may adjust the photosensitivity of the at least one imager 20 based on the input received. In some embodiments, blind spot reduction system 10 may further include an optional electro-optic element 36, and display element 26 may be viewed through electro-optic element 36. In some embodiments, processing system 22 may receive input from at least one of ambient light sensor 32 and glare sensor 34 and, based on the input received, may cause electro-optic element 36 to darken or to clear. In some embodiments, blind spot reduction system 10 may also comprise at least one position sensor 38 configured to sense the position of a viewer and to provide inputs related to the viewer's position to processing system 22.

The at least one imager 20 may be operative to view the scene exterior to the vehicle and may be any conventional imager. Examples of suitable imagers are disclosed in U.S. Pat. No. 8,289,430 entitled “High Dynamic Range Imaging Device” by Jon H. Bechtel et al., issued Oct. 16, 2012; U.S. Pat. No. 8,924,078, entitled “Image Acquisition and Processing System for Vehicle Equipment Control,” by Oliver M. Jeromin et al., issued Dec. 30, 2014; and “Imager System with Median Filter and Method Thereof” by Jon H. Bechtel et al., issued on Sep. 19, 2017; the entire disclosures of which are incorporated herein by reference.

The at least one imager 20 may be mounted in a variety of locations such as, but not limited to: within the pillar 41 of a vehicle, as shown in FIG. 2; in molding or trim of vehicle along, for example, the roof line of vehicle; inside an exterior side mirror assembly, in a rearview mirror assembly; or in any other suitable location, such as those disclosed in U.S. Pat. No. 6,611,610 entitled “Vehicle Lamp Control” by Joseph S. Stam, issued on Aug. 27, 2003, the entire disclosure of which is incorporated herein by reference. The field of view of the imager may comprise scenes to the exterior of the vehicle and, in particular, scenes that may be blocked from the view of an occupant of the vehicle by a vehicle pillar 41. The field of view of imager 20 may include, but is not limited to, the front, back, and sides of the vehicle.

The at least one imager 20 may be configured to capture video images of a scene or scenes outside the vehicle and to transmit data on the captured images to processing system 22. Processing system 22 may be configured to process the captured images and to cause the processed images to be displayed on display element 26 on the pillar 41 corresponding to the scene captured by the at least one imager 20. Information captured by the at least one imager 20 may be communicated by processing system 22 to the corresponding display element 26 in a similar manner to that disclosed in U.S. Pat. No. 8,237,909 entitled “Vehicular Rearview Mirror Assembly Including Integrated Backlighting for a Liquid Crystal Display” by John B. Ostreko, et al., issued on Aug. 7, 2012, the entire disclosure of which is incorporated herein by reference. In some embodiments, processing system 22 may further process the images to improve the scene displayed to the viewer by, for example, reducing glare or incoming light levels such as lights from oncoming headlights or the sun.

In some embodiments, display element 26 may be disposed on an interior surface 40 of pillar 41. Some vehicle pillars 41 may be configured to have at least one generally planar interior surface 40, such as vehicle pillars 41 having, for example, a generally rectangular cross-section, a generally triangular cross-section, or a generally trapezoidal cross-section. Some vehicle pillars 41 may be configured to have an interior surface 40 having a curved, angled, or other irregular configuration. In some embodiments, interior surface 40 of pillar 41 may have more than one face. Some pillars 41 such as, for example, B pillars may have one face that faces the interior of the vehicle and is visible during normal operation of vehicle. Other interior faces may be obscured by portions of a vehicle door extending vertically along vehicle windows during vehicle operation, and the portions of the vehicle door extending along vehicle windows may also contribute to blind spots.

In some embodiments, display element 26 may comprise at least one display panel 30. Display element 26 may be configured to correspond to the shape of at least a portion of interior surface 40 of vehicle pillar 41. In some embodiments, display element 26 may have a generally rectangular shape. However, it should be appreciated that display element 26 may have other shapes such as but not limited to trapezoidal, non-symmetrical, contoured, or an irregular shape. In some embodiments, display element 26 may comprise more than one display panel 30. In some embodiments, display element 26 may comprise a plurality of display panels 30, and each display panel 30 may be disposed adjacent to and in proximity to or abutting at least one other display panel 30. In some embodiments, each of the plurality of display panels 30 may be disposed spaced apart from other display panel(s) 30. In some embodiments, display panels 30 may be configured as at least one generally planar surface. In some embodiments, display panels 30 may have an irregular or contoured surface such as a curved surface. The curved surface may wrap around, at least in part, interior surface 40 of pillar 41.

In some embodiments, pillar 41 may comprise a plurality of interior surfaces 40, and display element 26 may be disposed on at least one interior surface 40 of pillar 41. In some embodiments, one of the at least one display panels 30 may occupy only a single face or only a portion of a single face of pillar 41. In some embodiments, a first display panel 30 may occupy at least a portion of a face of pillar 41 and a second display panel 30 may occupy at least a portion of the same or a different face of pillar 41 such that display panels 30 are disposed on a plurality of faces or portions of faces of pillar 41. In some embodiments, a single display panel 30 may be configured to wrap around interior surface 40 or a portion of interior surface 40 of pillar 41. In some embodiments, display element 26 may occupy the entire interior surface 40 of pillar 41. In some embodiments, display element 26 may occupy only a portion of interior surface 40 of pillar 41. For example, display panels 30 of display element 26 may be generally rectangular and interior surface 40 of vehicle pillar 41 may have a contoured shape that extends at least partially beyond display element 26.

In some embodiments, display panel(s) 30 may be disposed on a and generally parallel to a face of interior surface 40 of pillar 41. In some embodiments, display panels 30 may be set into the face of interior surface 40 of pillar 41 so that display panels 30 are flush with or recessed into the face of interior surface 40 of pillar 41. In some embodiments, a bezel or a ring (not shown) such as a chrome ring may extend at least partially around a perimeter of display panels 30 of display element 26. In some embodiments, the ring may be partially hidden by molding at ends of pillar 41, the vehicle's roof, the dashboard or other vehicle structure. In some embodiments, display element 26 may be coextensive with at least one interior surface 40 of vehicle pillar 41.

In some embodiments, display element 26 may comprise multiple display panels 30 and at least one display panel 30 may be disposed on each of more than one vehicle pillars 41. For example, at least one display panel 30 may be disposed in one A pillar 41 and one B pillar 41 of the vehicle. In some embodiments, display panels 30 may be disposed in both pillars 41 of a pair of pillars such as, for example, in both A pillars. In some embodiments, display panels 30 may be disposed in a plurality of pairs of pillars 41 such as, for example, in both A pillars and in both B pillars. Display panels 30 may be disposed in every pillar 41 of a vehicle. In some embodiments, display panels 30 associated with blind spot reduction system 10 may be disposed in the portions of vehicle doors that extend adjacent to vehicle windows and that obscure the view through the window, thereby creating a blind spot.

The at least one display panel 30 may comprise a light-emitting diode (LED), an organic light-emitting diode (OLED), a plasma, a digital light processing (DLP) display element, or other display technology. Display panel 30 may be of any of a variety of shapes and sizes, and may be associated with all or a portion of the interior surface 40 of pillar 41. Examples of assemblies having display devices can be found in U.S. Pat. No. 8,339,526 entitled “Vehicle Rearview Mirror Assembly Including a High Intensity Display” issued Dec. 25, 2012, by Danny L. Minikey; and U.S. Patent Application Publication No. US20090096937 A1 entitled “Vehicle Rearview Assembly Including a Display for Displaying Video Captured by a Camera and User Instructions” by Frederick T. Bauer et al., filed Apr. 16, 2009, the entire disclosures of which are incorporated herein by reference.

Processing system 22 may be wholly or partially incorporated with display element 26 or with the at least one imager 20, may be split between display element 26 and the at least one imager 20, or may be disposed separately from but in communication with display element 26 and the at least one imager 20. In some embodiments, processing system 22 may be configured to receive at least one NTSC (National Television Standards Committee) analog video signal from the at least one imager 20 and to display the content on display element 26 of pillar 41.

In some embodiments, the at least one of ambient light sensor 32 and glare sensor 34 may be disposed in an outer surface 42 of pillar, and processing system 22 may be in communication with at least one of ambient light sensor 32 and glare sensor 34. At least one of ambient light sensor 32 and glare sensor 34 may be configured to detect light levels forward of the vehicle, such as light coming from oncoming vehicles or from the sun. Ambient light sensor 32 and glare sensor 34 may measure information regarding brightness and/or glare and may communicate this information to blind spot reduction system 10.

In some embodiments, processing system 22 may be configured to receive input from ambient light sensor 32 to control the photosensitivity of the at least one imager 20. For example, processing system 22 may use a signal from ambient light sensor 32 to determine whether to place the at least one imager 20 in a bright mode or a dark mode setting. The bright mode setting may include one or more integration times that enable the at least one imager 20 to operate in high ambient light conditions, and the dark mode may include one or more integration times that enable the at least one imager 20 to operate in low ambient light conditions. Ambient light sensor 32 may be positioned in a variety of locations. For example, ambient light sensor 32 may be a forward-facing light sensor, such as the one described in U.S. Pat. No. 4,917,477 entitled “Automatic Rearview Mirror System for Automotive Vehicles” issued Apr. 4, 1990, by Jon H. Bechtel, the entire disclosure of which is incorporated herein by reference.

In some embodiments, processing system 22 may also be configured to receive input from glare sensor 34. For example, video images acquired by the at least one imager 20 may become saturated when the at least one imager 20 is operating in dark mode and is subsequently exposed to light levels in excess of prevailing ambient light conditions. For example, when driving at night, the bright headlights of approaching vehicles may cause the at least one imager 20 to be exposed to an excess of light and may also cause excessive glare on display element 26. In this scenario, ambient light levels may not necessarily change, and as such, processing system 22 may be unable to remedy the situation by relying solely on ambient light sensor 32. Instead, processing system 22 may rely on glare sensor 34, which may be placed in pillar 41 or in proximity to the at least one imager 20 so as to sense light levels falling on the at least one imager 20 or being transmitted to display element 26. Glare sensor 34 may subsequently send a signal to processing system 22. In response to excessive light or glare levels, processing system 22 may adjust the image displayed on display element 26 or may signal the at least one imager 20 to adjust the image displayed on display element 26 to prevent image saturation.

In some embodiments, at least one of ambient light sensor 32 and glare sensor 34 may be in communication with processing system 22. Processing system 22 may be configured to activate an electro-optic element 36 upon detection of light levels higher than a predetermined threshold level. This may reduce the brightness and/or glare of images displayed on display element 26.

In some embodiments, at least one aperture 44 in outer surface 42 of pillar 41 may allow ambient light to enter pillar 41 and provide light to display element 26. Using ambient light may use less energy than providing backlighting for display element 26. The at least one aperture 44 may be disguised. For example, the at least one aperture 44 may be hidden behind a molding, a decorative strip, or another feature of pillar 41, or may be otherwise camouflaged so as not to be easily seen. Although the at least one aperture 44 may allow light to enter pillar 41, a transparent or translucent cover 46 over aperture 44 may prevent air or water intrusion through the at least one aperture 44. Cover 46 may also be configured to prevent light inside pillar 41 from being seen through aperture 44 from viewers outside the vehicle.

In some embodiments, blind spot reduction system 10 may further comprise a light source 48. Light source 48 may be in electrical communication with processing system 22. Light source 48 may comprise, for example, a light emitting diode (LED). Light source 48 may be disposed to allow light to be transmitted to display element 26 such as, for example, by providing light to an optic block 50. Light may then propagate through optic block 50 and be guided to display element 26. Light provided by light source 48 may function as a backlight to illuminate images displayed on display element 26 when display element is activated. When necessary to provide light to display element 26, light source 48 may also be activated to allow it to provide light to display element 26.

In some embodiments, blind spot reduction system 10 may comprise both a light source 48 within pillar 41 and at least one aperture 44 in outer surface 42 of pillar 41. In some embodiments, an electro-optic element 52 or other device may be configured to allow ambient light to pass through outer surface 42 of pillar 41 to provide light to display element 26 when there is sufficient ambient light to do so. Electro-optic element 52 may also be configured to prevent light from light source 48 in the interior of pillar 41 from shining through outer surface 42 of pillar 41. Ambient light may be used to provide light to display element 26 only when ambient light levels are high enough to provide sufficient light to display element 26. At other times, a backlight may be used to provide backlighting for display element 26.

In some embodiments, blind spot reduction system 10 may comprise at least one position sensor 38 in communication with processing system 22. The at least one position sensor 38 may be disposed within or on the vehicle pillar 41, in a rearview assembly, in a vehicle dashboard, in a steering wheel, in an infotainment console, or in any other suitable location within or on the vehicle. The at least one position sensor 38 may be configured to determine a position of an object in proximity to pillar 41. In some embodiments, the object may be the head of a viewer. In some embodiments, the object may be the eyes of a viewer. Viewer may be in driver's seat of vehicle. Position sensor 38 may communicate information regarding the location of the viewer's eyes or head to processing system 22. Processing system 22 may be configured to use viewer's head or eye location to adjust the height and lateral position of the displayed image. This may allow processing system 22 to process images so that they may be displayed to align with the scene visible through the vehicle windshield or window from the viewer's perspective, thereby allowing the viewer to perceive an uninterrupted vista.

In some embodiments, blind spot reduction system 10 may further comprise a housing 56. Housing 56 may at least partially receive display element 26 and optic block 50. In some embodiments, at least a portion of at least one of processing system 22, light source 48, and optional electro-optic element 36 may be disposed in housing 56.

In some embodiments, electro-optic element 36 may be disposed generally parallel to display element 26, and display element 26 may be viewed through electro-optic element 36. In some embodiments, electro-optic element 36 may be at least partially encased within housing 56. Electro-optic element 36 may be in communication with at least one of glare sensor 34 and ambient light sensor 32. Electro-optic element 36 may be configured to selectively darken or clear, thereby attenuating light from very bright lights, such as direct sunlight or oncoming headlights, based on outputs generated by at least one of glare sensor 34 and ambient light sensor 32.

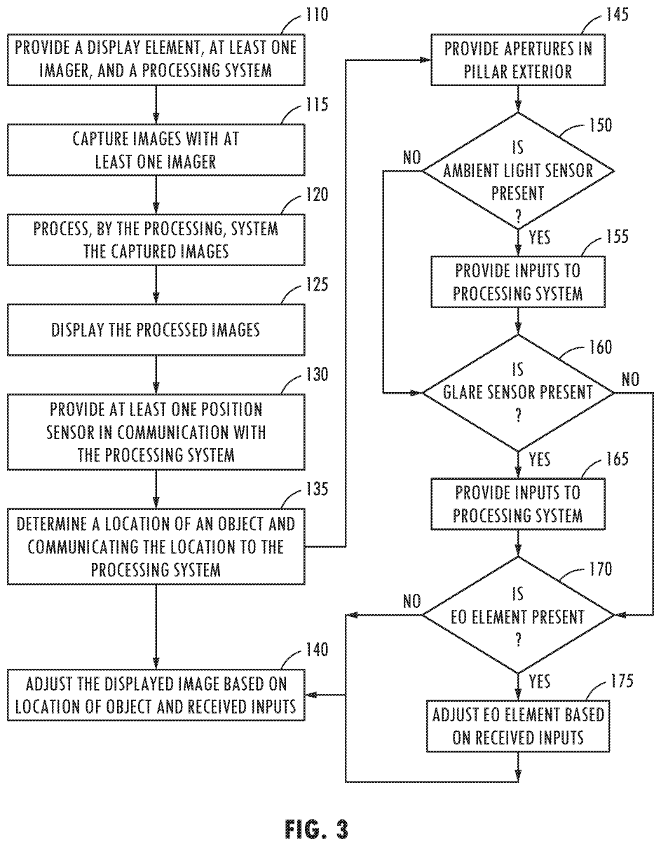

A method 100 of reducing blind spots in vehicles may comprise providing a display element 26 disposed on an interior surface 40 of a pillar 41 of a vehicle, at least one imager 20 configured to capture images, and a processing system 22 in communication with display element 26 and the at least one imager 20 as shown in in step 110 of FIG. 3. In some embodiments, display element 26 may comprise at least one display panel 30, and the at least one display panel 30 may comprise a light emitting diode. In some embodiments, display element 26 may be a liquid crystal display element. The at least one imager 20 may capture images in step 115. The captured images may be images of a scene exterior to the vehicle on which display element 26 is disposed, which scene may be blocked from the view of a viewer within the vehicle by pillar 41. Processing system 22 may process the captured images in step 120. Display element 26 may display the processed images in step 125.

The method may include providing at least one position sensor 38 in communication with processing system 22 in step 130. The at least one position sensor 38 may determine a location of an object and communicate the location to processing system 22 in step 135. Processing system 22 may use the location of the object to adjust the displayed image in accordance with input on the location of the object in step 140. The object may be the head or the eyes of a viewer. Adjusting the displayed image may comprise aligning the displayed image based on a position of a viewer's eyes to reduce or eliminate any discontinuities or breaks between what the viewer may see on display element 26 and what the viewer may see through an adjacent window.

In some embodiments, method 100 may further comprise providing apertures 44 in an exterior surface of pillar 41, wherein apertures 44 are configured to allow light to pass through apertures 44 from the exterior side of the pillar to an interior of the pillar, as shown in step 145.

In some embodiments, as shown in step 150, method 100 further may comprise providing an ambient light sensor 32 in communication with processing system 22. Ambient light sensor 32 may provide inputs regarding ambient light levels to processing system 22 in step 155. In step 160, the photosensitivity of the at least one imager 20 may be adjusted responsive to inputs on the ambient light levels.

In some embodiments, method 100 may further comprise the step 160 of providing a glare sensor 34 in communication with processing system 22. Glare sensor 34 may provide inputs to processing system 22 in step 165, and captured images may be adjusted prior to display based on the received inputs.

In some embodiments, method 100 may further comprise the step 170 of providing an electro-optic element 36 disposed in front of a viewing surface of display element 26. Electro-optic element 36 may be in communication with processing system 22. In step 175, electro-optic element 36 may darken or clear based on inputs received by processing system 22 from at least one of glare sensor 34 and ambient light sensor 32.

One non-limiting example of an electro-optic element 36 is an electro-optic medium, which includes at least one solvent, at least one anodic material, and at least one cathodic material. Typically, both of the anodic and cathodic materials are electroactive and at least one of them is electro-optic. It will be understood that regardless of its ordinary meaning, the term “electroactive” will be defined herein as a material that undergoes a modification in its oxidation state upon exposure to a particular electrical potential difference.

The above description is considered that of the preferred embodiments only. Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It should be noted that references to “front,” “back,” “rear,” “upward,” “downward,” “inner,” “outer,” “right,” and “left” in this description are merely used to identify the various elements as they are oriented in the FIGURES. These terms are not meant to limit the element which they describe, as the various elements may be oriented differently in various applications.

1. A blind spot reduction system comprising:
a display element disposed on an interior surface of a pillar of a vehicle;
at least one imager configured to capture images of a scene exterior to the vehicle; and
a processing system in communication with the display element and the at least one imager;
wherein the processing system is configured to process the captured images; and
wherein the display element is configured to display the processed images.

2. The blind spot reduction system of claim 1, further comprising at least one position sensor in communication with the processing system;
wherein the position sensor is configured to determine a location of an object and to communicate the location to the processing system.

3. The blind spot reduction system of claim 2, wherein the processing system is configured to adjust the displayed image based on the location of the object.

4. The blind spot reduction system of claim 3, wherein the at least one imager is configured to capture images of a scene that is blocked from the view of a vehicle occupant by the pillar; and
wherein the processing system is configured to use the location of the object to adjust the captured images to cause the display element to display images of the scene blocked from the view of the vehicle occupant by the vehicle pillar.

5. The blind spot reduction system of claim 1, further comprising apertures in an exterior surface of the pillar;
wherein the apertures are configured to allow light to pass through the apertures from the exterior side of the pillar to an interior of the pillar to provide light to the display element.

6. The blind spot reduction system of claim 1, further comprising a light source in communication with the processing system and configured to provide light to the display element.

7. The blind spot reduction system of claim 1, wherein the display element comprises at least one display panel; and
wherein the at least one display panel comprises a light emitting diode.

8. The blind spot reduction system of claim 1, further comprising an ambient light sensor in communication with the processing system and configured to provide inputs regarding ambient light levels to the processing system.

9. The blind spot reduction system of claim 8, wherein the photosensitivity of the at least one imager is adjustable based on the inputs generated by the ambient light sensor and communicated to the processing system.

10. The blind spot reduction system of claim 1, further comprising a glare sensor in communication with the processing system and configured to provide inputs regarding glare to the processing system.

11. The blind spot reduction system of claim 10, wherein the processing system is configured to adjust the images to be displayed on the display element in response to the inputs generated by the glare sensor.

12. The blind spot reduction system of claim 1, further comprising at least one of an ambient light sensor and a glare sensor;
wherein the at least one of an ambient light sensor and glare sensor is in communication with the processing system and is configured to provide inputs to the processing system.

13. The blind spot reduction system of claim 12, further comprising an electro-optic element in communication with the processing system;
wherein the display element is viewed through the electro-optic element; and
wherein the electro-optic element is activated based on inputs provided to the processing system by the at least one of an ambient light sensor and a glare sensor.

14. A blind spot reduction system for a vehicle, comprising:
a display element disposed on an interior surface of a pillar of a vehicle;
at least one imager having a field of view, the imager configured to capture images of a scene exterior to the vehicle; and
a processing system in communication with the display element and the at least one imager;
wherein the processing system is configured to process the captured images;
wherein the display element is configured to display the processed images; and
wherein the field of view of the imager includes a scene that is blocked from the view of a vehicle occupant by the pillar in which the display element is disposed.

15. A method for reducing blind spots in vehicles comprising:
providing a display element, at least one imager, and a processing system;
capturing images of a scene to the exterior of the vehicle with the at least one imager;
and
displaying the captured images on the display element;
wherein the display element is on an interior surface of a vehicle pillar.

16. The method of claim 15, further comprising the step of processing, by the processing system, the captured images prior to display.

17. The method of claim 15, further comprising the steps of:
providing at least one position sensor in communication with the processing system; and
determining, by the at least one position sensor, a location of an object, and communicating the location of the object to the processing system.

18. The method of claim 17, further comprising the step of adjusting, based on received inputs from the at least one position sensor, the displayed image.

19. The method of claim 17, wherein the object is one of the head or eyes of a viewer, and wherein the captured images are images of a scene exterior to the vehicle, which scene is blocked from the view of the viewer by the vehicle pillar.

20. The method of claim 15, further comprising the steps of:
providing at least one of a glare sensor and an ambient light sensor in communication with and configured to provide inputs to the processing system;
providing an electro-optic element disposed between the display element and the location of a viewer and in communication with the processing system; and
adjusting the darkness of the electro-optic element based on inputs provided to the processing system by the at least one of the glare sensor and the ambient light sensor.
